(19) United States
(12) Patent Application Publication
(10) Pub. No.: US 2021/0218241 A1
(43) Pub. Date: Jul. 15, 2021

(54) POWER SUPPLY CIRCUIT AND ELECTRONIC DEVICE

(71) Applicant: FUJITSU LIMITED, Kawasaki-shi, (JP)

(72) Inventor: TOMOYOSHI KITAMURA, Kawasaki (JP)

(73) Assignee: FUJITSU LIMITED, Kawasaki-shi (JP)

(21) Appl. No.: 17/096,996

(22) Filed: Nov. 13, 2020

(30) Foreign Application Priority Data
Jan. 15, 2020 (JP) 2020-004665

(51) Int. Cl. H02H 3/44; H02J 1/06; H02H 1/00

(52) U.S. Cl. CPC H02H 3/445; H02H 1/0007; H02J 1/06

(57) ABSTRACT

A power supply circuit includes a power supply line through which DC power input from a first connector to a second connector is supplied to a power supply that generates a power based on the DC power; a waveform output circuit configured to output a voltage waveform sloped when an arc is occurring between the first connector and the second connector; and a control circuit configured to output to the power supply an instruction for turning off the power supply when a slope of the voltage waveform exceeds a threshold.

### CROSS-REFERENCE TO RELATED APPLICATION

This application is based upon and claims the benefit of priority of the prior Japanese Patent Application No. 2020-4665, filed on Jan. 15, 2020, the entire contents of which are incorporated herein by reference.

### FIELD

The embodiments discussed herein are related to a power supply circuit and an electronic device.

### BACKGROUND

There is a technique for determining whether a current value or a voltage value supplied to a load is abnormal, and when it is determined that the current value or the voltage value is abnormal, determining that an arc discharge is occurring and controlling a switching device to stop supply of power to the load from a power supply. As related art, for example, Japanese Laid-open Patent Publication No. 2002-125310 and the like are disclosed.

### SUMMARY

According to an aspect of the embodiments, a power supply circuit includes a power supply line through which DC power input from a first connector to a second connector is supplied to a power supply that generates a power based on the DC power; a waveform output circuit configured to output a voltage waveform sloped when an arc is occurring between the first connector and the second connector; and a control circuit configured to output to the power supply an instruction for turning off the power supply when a slope of the voltage waveform exceeds a threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of an electronic device according to a first embodiment;

FIG. 2 is a diagram illustrating a voltage waveform and a current waveform in a case where no arc is occurring;

FIG. 3 is a diagram illustrating a voltage waveform and a current waveform in a case where an arc is occurring;

FIG. 4 is a flowchart illustrating a flow of internal processing of a control circuit;

FIG. 5 is a diagram illustrating a configuration example of a power supply circuit according to the first embodiment;

FIG. 6 is a diagram illustrating a configuration example of an electronic device according to a second embodiment;

FIG. 7 is a diagram illustrating a configuration example of a power supply circuit according to the second embodiment;

FIG. 8 is a diagram illustrating a configuration example of an electronic device according to a third embodiment;

FIG. 9 is a diagram illustrating voltage waveforms and a current waveform in a case where an arc is occurring;

FIG. 10 is a diagram illustrating a configuration example of a power supply circuit according to the third embodiment;

FIG. 11 is a diagram illustrating a first configuration example of an antenna;

FIG. 12 is a diagram illustrating a second configuration example of the antenna;

FIG. 13 is a diagram illustrating a configuration example of an electronic device according to a fourth embodiment; and

FIG. 14 is a diagram illustrating a hardware configuration example of a control circuit.

### DESCRIPTION OF EMBODIMENTS

When a current keeps flowing in a load under an occurrence of an arc, the occurrence of the arc continues. When the occurrence of the arc continues, for example, a portion where the arc is occurring may be damaged.

In view of the above, it is desirable to suppress the continued occurrence of an arc.

Hereinafter, embodiments according to the present disclosure are described.

An electronic device according to an embodiment of the present disclosure operates based on DC power supplied from a DC power supply device. Specific examples of the electronic device include an information device such as a server, a communication device such as a network device or a communication base station, and an in-vehicle device such as an in-vehicle computer. However, the specific examples are not limited to these devices. The DC power supply device supplies power to the electronic device using a DC power transmission system. An example of the DC power transmission system includes higher voltage direct current (HVDC).

In recent years, the processing speed of semiconductor devices such as a large scale integration (LSI), a central processing unit (CPU), and a field-programmable gate array (FPGA) has been increasing. With the increase in the processing speed of the semiconductor devices, the desired current capacity increases. In this context, a very large amount of power is desired to be supplied to facilities such as a datacenter and a communication facility where a large number of information technology (IT) devices are used. When current consumed in an electronic device increases, a power supply system with relatively low voltage may face facility limitations and result in non-negligible energy loss. Higher efficiency and resource saving in terms of power supply cables achieved by the HVDC have been attracting more attention for the sake of energy saving. Thus, the practical use of the HVDC has been under way.

Unfortunately, with the DC high-voltage power supply, an arc occurring at the time of a DC circuit break continues for a long period of time, compared with that at the time of an AC circuit break. This is because with AC, voltage and current pass through zero cross where their values become zero, and thus pass through a zero point where energy causing the arc is absent. In contrast, with the DC high-voltage power supply, voltage and current do not pass through the zero point, and thus the arc energy is continuously supplied. The continued occurrence of an arc creates a risk of damaging the device. Thus, there has been a demand for a solution to extinguish an arc as quickly as possible, at the time of breaking the DC for high voltage power supply.

The HVDC is used in facilities to be operated around the clock, such as a datacenter for example. It is difficult to turn off the power supply in such facilities, even when the purpose is for maintenance, replacement, or the like. Thus, hot swap is desirably implemented safely. An arc discharge occurs between a power transmission side and a power reception side when the coupling between the power transmission side and the power reception side is interrupted while a load on the power reception side is under operation. The continued occurrence of the arc discharge involves a risk of damaging a part on at least one of the power transmission side and the power reception side.

A power supply circuit and an electronic device according to embodiments of the present disclosure have a function of suppressing the continued occurrence of an arc between a power transmission unit and a power reception unit. Hereinafter, some embodiments will be described.

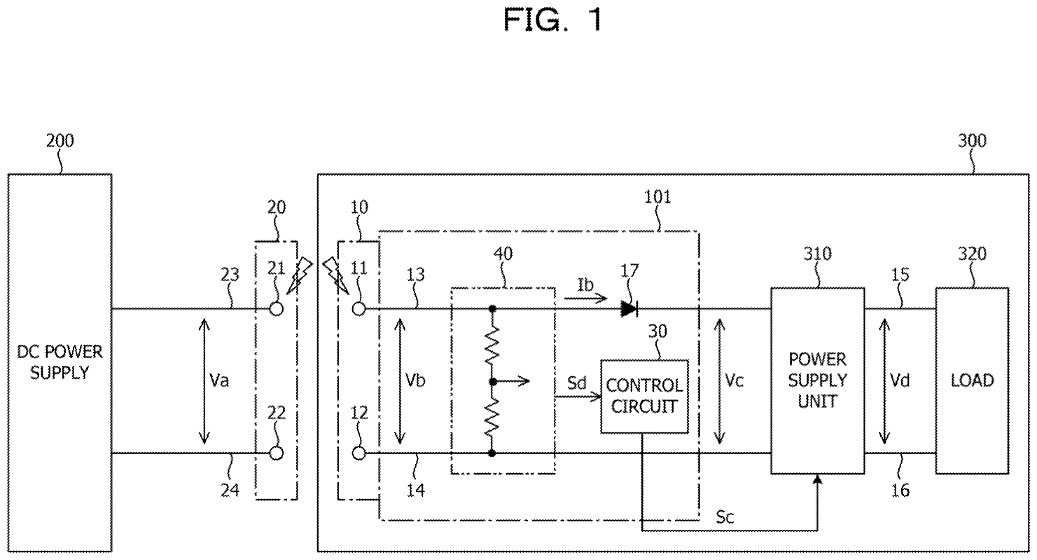

FIG. 1 is a diagram illustrating a configuration example of an electronic device according to a first embodiment. An electronic device 300 illustrated in FIG. 1 operates based on DC power supplied from a DC power supply device 200. Specific examples of the electronic device 300 include, but are not limited to, the above-described information devices, communication devices, and the like.

The DC power supply device 200 is a device that supplies DC power to the electronic device 300, using the HVDC system for example. The DC power supply device 200 outputs DC voltage Va from a power transmission connector 20 to the electronic device 300 through a pair of power transmission lines 23 and 24.

The power transmission connector 20 is an example of a power transmission unit (first connector) and includes a pair of power transmission terminals 21 and 22. The positive-side power transmission line 23 establishes conductive coupling between a positive terminal of the DC power supply device 200 and the positive-side power transmission terminal 21. The negative-side power transmission line 24 establishes conductive coupling between a negative terminal of the DC power supply device 200 and the negative-side power transmission terminal 22. The DC voltage Va is a difference in potential between the pair of power transmission lines 23 and 24 (or between the pair of power transmission terminals 21 and 22).

The electronic device 300 operates based on DC power supplied from the DC power supply device 200 via the power transmission connector 20. The electronic device 300 includes a power supply circuit 101, a power supply unit 310, and a load 320.

The power supply circuit 101 includes a power reception connector 10 that receives the DC power supplied from the DC power supply device 200 via the power transmission connector 20, and supplies the DC power received by the power reception connector 10 to the power supply unit 310. In a state where the power transmission connector 20 and the power reception connector 10 are coupled to each other, the DC power is input from the power transmission connector 20 to the power reception connector 10. One of the power transmission connector 20 and the power reception connector 10 is a female connector, and the other is a male connector. The power supply circuit 101 may be disposed inside or outside the electronic device 300.

The power supply unit 310 generates power supply for the load 320 (DC power for the operation of the load 320) based on the DC power input from the power transmission connector 20 to the power reception connector 10. The power supply unit 310 is a DC-DC converter. The power supply unit 310 steps down DC voltage Vc from the power supply circuit 101 to generate DC voltage Vd, and outputs the stepped-down DC voltage Vd to a pair of output lines 15 and 16. Specific examples of the power supply unit 310 include a switching regulator, a series regulator, and the like.

The load 320 is operated by DC power supplied from the power supply unit 310 through the pair of output lines 15 and 16, and receives the DC voltage Vd. The DC voltage Vd is a difference in potential between the pair of output lines 15 and 15. The load 320 may be the above-described semiconductor device or another device.

The power supply circuit 101 includes the power reception connector 10, a pair of power supply lines 13 and 14, a waveform output circuit 40, and a control circuit 30. The power supply circuit 101 may include a smoothing circuit that smooths DC voltage Vb input from the power reception connector 10.

The power reception connector 10 is an example of a power reception unit (second connector) that receives power supply from the power transmission unit, and is configured to be couplable to the power transmission connector 20. The power reception connector 10 includes a pair of power reception terminals 11 and 12. In a state where the power reception connector 10 is coupled to the power transmission connector 20, the power reception terminal 11 is conductively coupled to the power transmission terminal 21, and the power reception terminal 12 is conductively coupled to the power transmission terminal 22.

The pair of power supply lines 13 and 14 are power reception lines through which the DC power input from the power transmission connector 20 to the power reception connector 10 is supplied to the power supply unit 310. The positive-side power supply line 13 establishes conductive coupling between the positive-side power reception terminal 11 and a positive-side input terminal of the power supply unit 310. The negative-side power supply line 14 establishes conductive coupling between the negative-side power reception terminal 12 and a negative-side input terminal of the power supply unit 310. The DC voltage Vb is a difference in potential between the pair of power supply lines 13 and 14 (or between the pair of power reception terminals 11 and 12). At least a part of the power supply line 13 may be formed from a conductive pattern or a power supply cable. Similarly, at least a part of the power supply line 14 may be formed from a conductive pattern or a power supply cable. The pair of power supply lines 13 and 14 supplies the DC power, input from the power transmission connector 20 via the power reception connector 10, to the power supply unit 310.

The power supply circuit 101 may be configured to suppress backflow of current from the power supply unit 310 side to the power reception connector 10 side (power transmission connector 20 side). FIG. 1 illustrates a configuration in which a diode 17 serving as an anti-backflow device is inserted in series in the power supply line 13.

The waveform output circuit 40 is a monitor circuit that outputs a voltage waveform Sd sloped when an arc is occurring between the power transmission connector 20 and the power reception connector 10. The arc is also referred to as an arc discharge. The voltage waveform Sd represents an analog voltage signal. The waveform output circuit 40 detects any abnormal voltage while the arc is occurring, and outputs a voltage waveform Sd representing a result of the detection.

When the power transmission connector 20 coupled to the power reception connector 10 is removed from the power reception connector 10 while the power reception connector 10 and the power transmission connector 20 are electrically coupled to each other, an arc may occur between the power transmission connector 20 and the power reception connector 10. For example, an arc may occur between the power transmission terminal 21 and the power reception terminal 11, or an arc may occur between the power transmission terminal 22 and the power reception terminal 12.

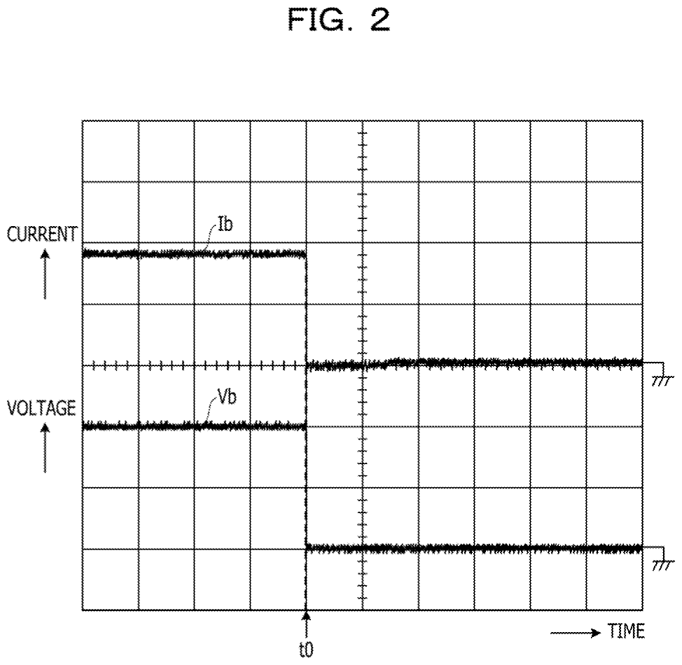

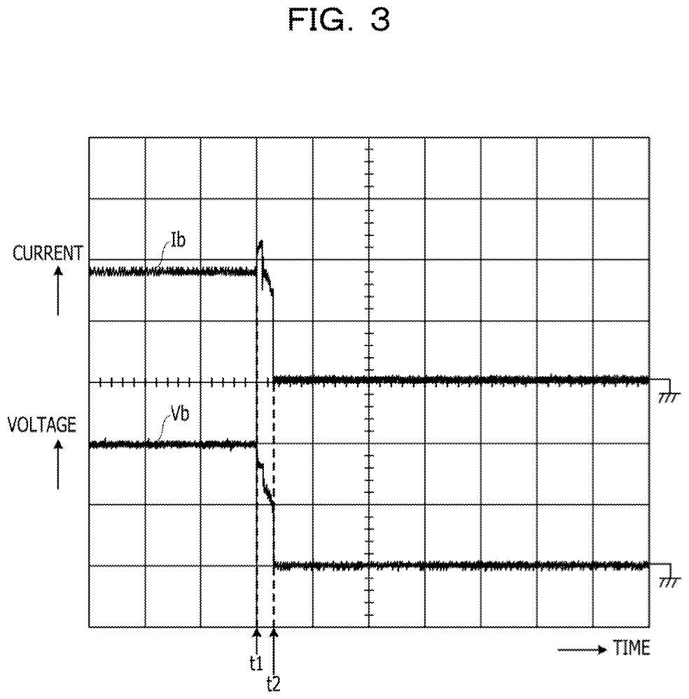

FIG. 2 is a diagram illustrating a voltage waveform and a current waveform in a case where no arc is occurring between the power transmission connector 20 and the power reception connector 10. FIG. 3 is a diagram illustrating a voltage waveform and a current waveform in a case where an arc is occurring between the power transmission connector 20 and the power reception connector 10. In FIGS. 2 and 3, the DC voltage Vb represents voltage between the pair of power supply lines 13 and 14 (or between the pair of power reception terminals 11 and 12), and DC current Ib represents current flowing in the power supply line 13.

The waveform output circuit 40 outputs the voltage waveform Sd in accordance with a change in the voltage (in this case, the DC voltage Vb) input to the power reception connector 10. The waveform output circuit 40 outputs the voltage waveform Sd that changes substantially in the same waveform as the DC voltage Vb.

In FIG. 2, when the coupling between the power transmission connector 20 and the power reception connector 10 is interrupted at a timing t0, the DC voltage Vb instantaneously drops to 0 at the timing t0 with substantially no slope. For example, when no arc is occurring between the power transmission connector 20 and the power reception connector 10, the DC voltage Vb and the voltage waveform Sd have no slope, and thus the time (period) during which the DC voltage Vb and the voltage waveform Sd are sloped is 0.

In FIG. 3, when the coupling between the power transmission connector 20 and the power reception connector 10 is interrupted at a timing t1, the DC voltage Vb drops to 0 while sloping from the timing t1 to a timing t2. For example, when an arc is occurring between the power transmission connector 20 and the power reception connector 10, the DC voltage Vb and the voltage waveform Sd are sloped, and the time (period) during which the DC voltage Vb and the voltage waveform Sd are sloped is greater than 0.

Using this feature, the control circuit 30 outputs an instruction Sc for stopping the power supply generation operation of the power supply unit 310 based on the slope of the voltage waveform Sd. When an arc occurs, the DC voltage Vb and the voltage waveform Sd involve an abnormal voltage drop, which is a behavior different from that in a case where no arc is occurring. The control circuit 30 detects the abnormal voltage drop, which is a behavior different from that in a case where no arc is occurring, based on the slope of the voltage waveform Sd due to the voltage drop. A continued arc results in a waveform with a continued abnormal voltage drop. The control circuit 30 determines that an arc is occurring by detecting a several-millisecond slope of the voltage waveform Sd.

When the slope of the voltage waveform Sd (hereinafter, also referred to as a slope A) exceeds a predetermined threshold B, the control circuit 30 outputs the instruction Sc for turning off the power supply to the load 320, to the power supply unit 310. Alternatively, the control circuit 30 may output, to the power supply unit 310, the instruction Sc for turning off the power supply to the load 320 when a time during which the voltage waveform Sd is sloped (hereinafter, also referred to as a sloped time C) exceeds a predetermined threshold D.

When the instruction Sc for turning off the power supply to the load 320 is output to the power supply unit 310, the power supply unit 310 turns off the power supply to the load 320, and thus the current (load current) consumed by the load 320 sharply decreases. The sharp decrease in the load current results in a sharp decrease in the DC current Ib flowing in the power reception terminal 11 of the power reception connector 10. Consequently, the arc occurring between the power transmission connector 20 and the power reception connector 10 may be swiftly reduced. Thus, the continued occurrence of the arc may be suppressed.

The control circuit 30 differentiates the voltage waveform Sd to calculate the slope A of the voltage waveform Sd. For example, the control circuit 30 calculates the time rate of change of the voltage waveform Sd by dividing the change amount of the voltage waveform Sd by a time of the change, as the slope A of the voltage waveform Sd.

The control circuit 30 differentiates the voltage waveform Sd at a predetermined calculation interval. For example, when the control circuit 30 differentiates the voltage waveform Sd that changes substantially in the same behavior as the DC voltage Vb illustrated in FIG. 2, the slope A at the timing t0 is calculated to be negative infinity. By contrast, when the control circuit 30 differentiates the voltage waveform Sd that changes substantially in the same behavior as the DC voltage Vb illustrated in FIG. 3, the slope A in the section from the timing t1 to the timing t2 is calculated to be a negative value (finite value).

Thus, with the threshold B set to a negative finite value smaller than 0, the control circuit 30 may output the instruction Sc for turning off the power supply to the load 320, to the power supply unit 310 when it is determined that the slope A exceeds the threshold B (negative finite value).

In a period with no change in the DC voltage Vb and the voltage waveform Sd, the control circuit 30 calculates the slope A to be 0 (since the voltage waveform Sd is not sloped in the first place), and thus does not determine that the slope A exceeds the threshold B. At the timing t0 illustrated in FIG. 2, the control circuit 30 calculates the slope A to be negative infinity (since the voltage waveform Sd instantaneously drops to 0 without a slope, meaning that the voltage waveform Sd is not sloped in the first place), and thus does not determine that the slope A exceeds the threshold B.

As described above, the control circuit 30 may output the instruction Sc for turning off the power supply to the load 320, to the power supply unit 310, when the sloped time C of the voltage waveform Sd exceeds the predetermined threshold D. For example, in the case illustrated in FIG. 3, the sloped time C is a period from the timing t1 to the timing t2. In order to distinguish between the case where no arc is occurring (FIG. 2) and the case where an arc is occurring (FIG. 3), the threshold D may be set to a time longer than 0 and shorter than the time from the timing t1 to the timing t2.

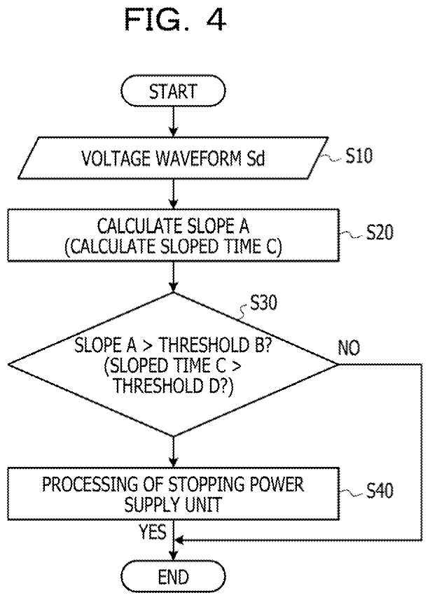

FIG. 4 is a flowchart illustrating a flow of internal processing of the control circuit. The control circuit 30 periodically repeats this internal processing. The control circuit 30 acquires the voltage waveform Sd (step S10). The control circuit 30 calculates the slope A of the voltage waveform Sd (step S20). The control circuit 30 determines whether the slope A exceeds the threshold B (step S30). Upon determining that the slope A exceeds the threshold B, the control circuit 30 determines that an arc has occurred, and executes processing of stopping the power supply unit 310 (step S40). In step S40, the control circuit 30 outputs the instruction Sc for turning off the power supply to the load 320, to the power supply unit 310. Upon determining that the slope A does not exceed the threshold B, the control circuit 30 determines that no arc is occurring, and does not execute the processing of stopping the power supply unit 310 (does not output the instruction Sc).

The control circuit 30 may calculate the sloped time C in step S20 and determine whether the sloped time C exceeds the threshold D in step S30. In this case, upon determining that the sloped time C exceeds the threshold D, the control circuit 30 determines that an arc has occurred, and executes processing of stopping the power supply unit 310 (step S40). Upon determining that the sloped time C does not exceed the threshold D, the control circuit 30 determines that no arc is occurring, and does not execute the processing of stopping the power supply unit 310 (does not output the instruction Sc).

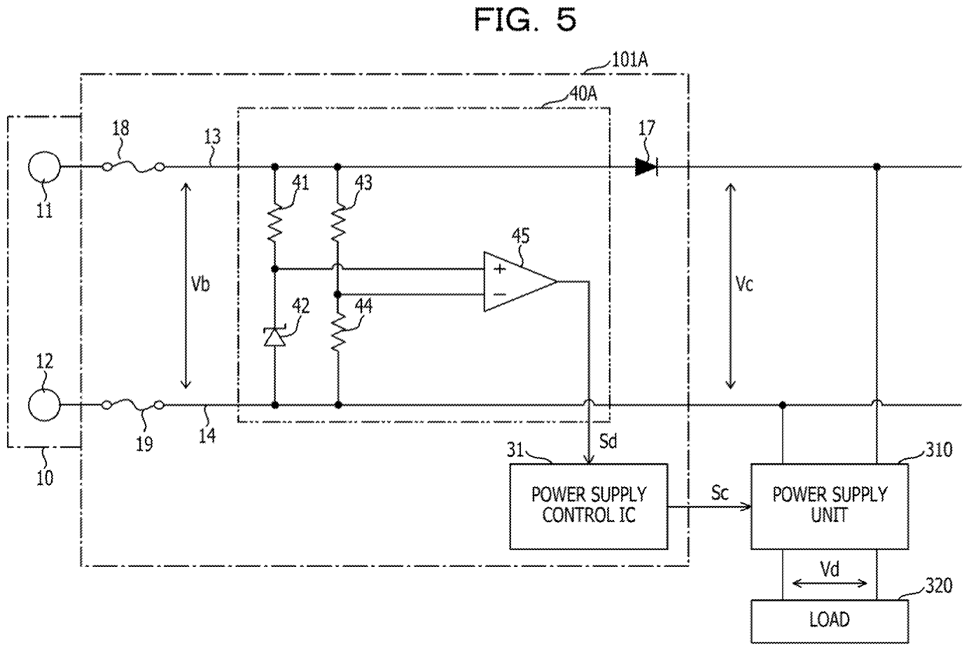

FIG. 5 is a diagram illustrating a configuration example of a power supply circuit according to the first embodiment. A power supply circuit 101A illustrated in FIG. 5 is an example of the power supply circuit 101 (FIG. 1). The power supply circuit 101A includes the power reception connector 10, the pair of power supply lines 13 and 14, a voltage detection circuit 40A, and a power supply control integrated circuit (IC) 31. The voltage detection circuit 40A is an example of the waveform output circuit 40 (FIG. 1), and the power supply control IC 31 is an example of the control circuit 30 (FIG. 1).

A fuse 18 is inserted in series in the power supply line 13, and a fuse 19 is inserted in series in the power supply line 14. With the fuses inserted, the power supply circuit and the electronic device may be protected from DC overcurrent Ib attributable to an arc, a short circuit, or the like.

The voltage detection circuit 40A monitors the DC voltage Vb input to the pair of power supply lines 13 and 14, to detect a change in the DC voltage Vb input to the power reception connector 10. The voltage detection circuit 40A outputs the voltage waveform Sd sloped when an arc is occurring between the power transmission connector 20 and the power reception connector 10, in accordance with a change in the DC voltage Vb input to the power reception connector 10.

The voltage detection circuit 40A includes, for example, a resistor 41, a Zener diode 42, a resistor 43, a resistor 44, and an amplifier 45. An overvoltage protection circuit in which the resistor 41 and the Zener diode 42 are coupled in series is coupled between the pair of power supply lines 13 and 14. With this overvoltage protection circuit, no DC overvoltage Vb exceeding the Zener voltage of the Zener diode 42 is applied to a non-inverting input terminal of the amplifier 45. A voltage dividing circuit in which the resistor 43 and the resistor 44 are coupled in series is coupled between the pair of power supply lines 13 and 14. This voltage dividing circuit inputs a divided voltage value, obtained by dividing the DC voltage Vb with the resistors 43 and 44, to an inverting input terminal of the amplifier 45. The amplifier 45 amplifies an input voltage (a difference in potential between the non-inverting input terminal and the inverting input terminal) corresponding to the magnitude of the DC voltage Vb, and outputs an analog voltage waveform Sd equivalent to the magnitude of the DC voltage Vb.

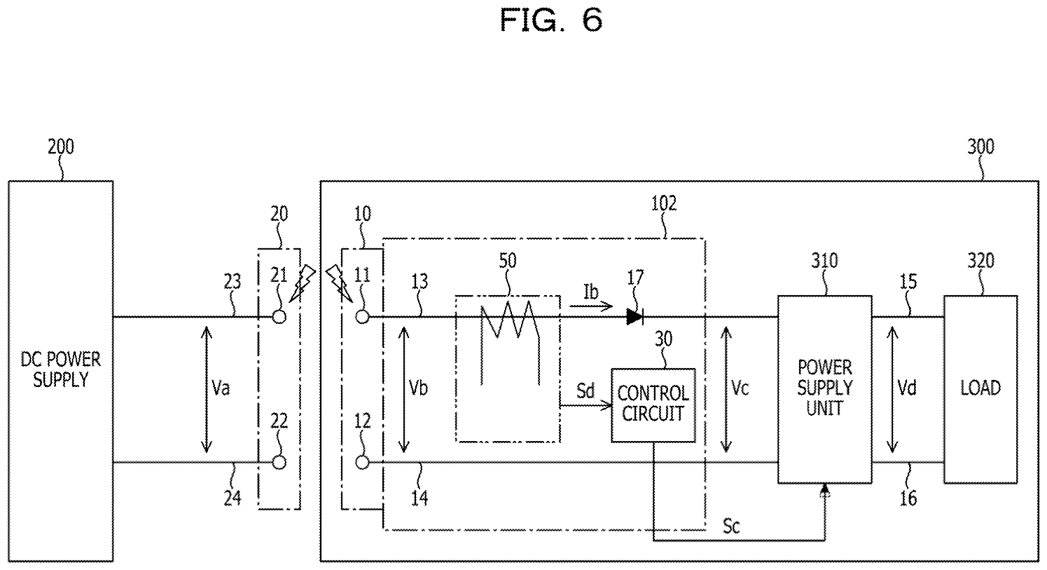

FIG. 6 is a diagram illustrating a configuration example of an electronic device according to a second embodiment. Description of the same configuration as that of the above-described embodiment will be omitted by incorporating the foregoing description. A power supply circuit 102 illustrated in FIG. 6 includes a waveform output circuit 50 instead of the waveform output circuit 40 in the power supply circuit 101 illustrated in FIG. 1.

The waveform output circuit 50 is a monitor circuit that outputs a voltage waveform Sd sloped when an arc is occurring between the power transmission connector 20 and the power reception connector 10. The waveform output circuit 50 detects an abnormal current under an occurrence of an arc, and outputs the voltage waveform Sd representing a result of the detection.

The waveform output circuit 50 outputs the voltage waveform Sd in accordance with a change in the current (in this case, the DC current Ib) input to the power reception connector 10. The waveform output circuit 50 outputs the voltage waveform Sd that changes substantially in the same manner as the waveform of the DC current Ib.

In FIG. 2, when the coupling between the power transmission connector 20 and the power reception connector 10 is interrupted at the timing t0, the DC current Ib instantaneously drops to 0 at the timing t0 with substantially no slope. For example, with no arc occurring between the power transmission connector 20 and the power reception connector 10, the DC current Ib and the voltage waveform Sd have no slope, and thus the time (period) during which the DC current Ib and the voltage waveform Sd are sloped is 0.

In FIG. 3, when the coupling between the power transmission connector 20 and the power reception connector 10 is interrupted at the timing t1, the DC current Ib drops to 0 while sloping from the timing t1 to the timing t2. For example, when an arc is occurring between the power transmission connector 20 and the power reception connector 10, the DC current Ib and the voltage waveform Sd are sloped, and the time (period) during which the direct current Ib and the voltage waveform Sd are sloped is greater than 0.

Using this feature, also in the second embodiment, the control circuit 30 outputs the instruction Sc for stopping the power supply generation operation of the power supply unit 310 based on the slope of the voltage waveform Sd. When an arc occurs, the DC current Ib involves a current drop accompanied by abnormal oscillation, which is a behavior different from that in a case where no arc is occurring. The control circuit 30 detects the current drop accompanied by abnormal oscillation, which is a behavior different from that in a case where no arc is occurring, based on the slope of the voltage drop on the voltage waveform Sd. A continued arc results in a waveform with a continued current drop accompanied by abnormal oscillation. The control circuit 30 determines that an arc is occurring by detecting a several-millisecond slope of the voltage waveform Sd.

Also in the second embodiment, the control circuit 30 outputs the instruction Sc for turning off the power supply to the load 320, to the power supply unit 310, when the slope A of the voltage waveform Sd exceeds the predetermined threshold B. Alternatively, the control circuit 30 may output the instruction Sc for turning off the power supply to the load 320, to the power supply unit 310, when the sloped time C of the voltage waveform Sd exceeds the predetermined threshold D. With the instruction Sc thus output, the continued occurrence of the arc may be suppressed.

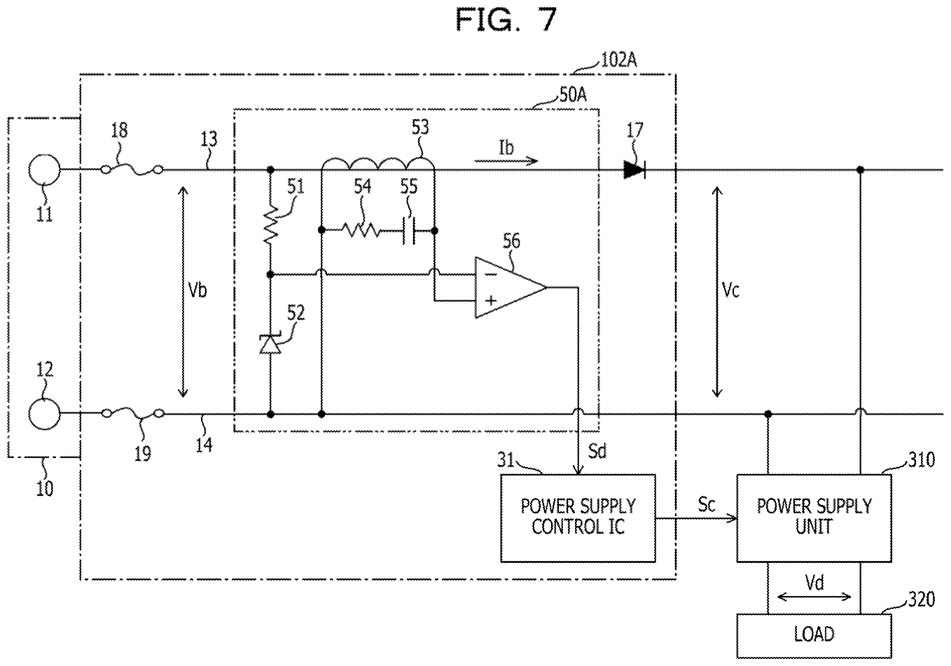

FIG. 7 is a diagram illustrating a configuration example of a power supply circuit according to the second embodiment. A power supply circuit 102A illustrated in FIG. 7 is an example of the power supply circuit 102 (FIG. 6). The power supply circuit 102A includes a current detection circuit 50A instead of the voltage detection circuit 40A illustrated in FIG. 5. The current detection circuit 50A is an example of the waveform output circuit 50 (FIG. 6).

The current detection circuit 50A monitors the DC current Ib flowing in the power supply line 13, to detect a change in the DC current lb input to the power reception connector 10. The current detection circuit 50A outputs the voltage waveform Sd sloped when an arc is occurring between the power transmission connector 20 and the power reception connector 10, in accordance with a change in the DC current Ib input to the power reception connector 10.

The current detection circuit 50A includes, for example, a resistor 51, a Zener diode 52, a current transformer 53, a resistor 54, a capacitor 55, and an amplifier 56. An overvoltage protection circuit in which the resistor 51 and the Zener diode 52 are coupled in series is coupled between the pair of power supply lines 13 and 14. With this overvoltage protection circuit, no DC overvoltage Vb exceeding the Zener voltage of the Zener diode 52 is applied to an inverting input terminal of the amplifier 56. The current transformer 53 generates a detection voltage corresponding to the magnitude of the DC current Ib flowing in the power supply line la The detection voltage is input to a non-inverting input terminal of the amplifier 56. A CR smoothing circuit in which the resistor 54 and the capacitor 55 are coupled in series smooths the detection voltage. The amplifier 56 amplifies the input voltage (difference in potential between the non inverting input terminal and the inverting input terminal) corresponding to the magnitude of the DC current Ib, and outputs the analog voltage waveform Sd equivalent to the magnitude of the DC current Ib.

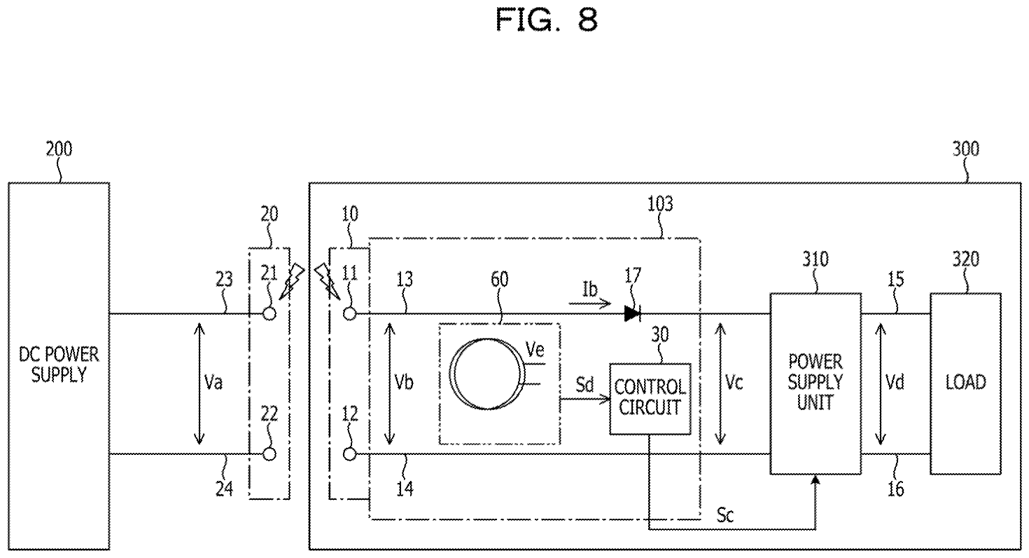

FIG. 8 is a diagram illustrating a configuration example of an electronic device according to a third embodiment. Description of the same configuration as that of the above-described embodiment will be omitted by incorporating the foregoing description. A power supply circuit 103 illustrated in FIG. 8 includes a waveform output circuit 60 instead of the waveform output circuit 40 of the power supply circuit 101 illustrated in FIG. 1.

The waveform output circuit 60 is a monitor circuit that outputs voltage waveform Sd sloped when an arc is occurring between the power transmission connector 20 and the power reception connector 10. The waveform output circuit 60 detects abnormal electromagnetic field radiation while the arc is occurring, and outputs the voltage waveform Sd representing a result of the detection.

The waveform output circuit 60 outputs the voltage waveform Sd in accordance with a change in electromagnetic noise input to the power reception connector 10. The waveform output circuit 60 detects electromagnetic noise using an antenna, and outputs the voltage waveform Sd oscillating in accordance with the detected electromagnetic noise.

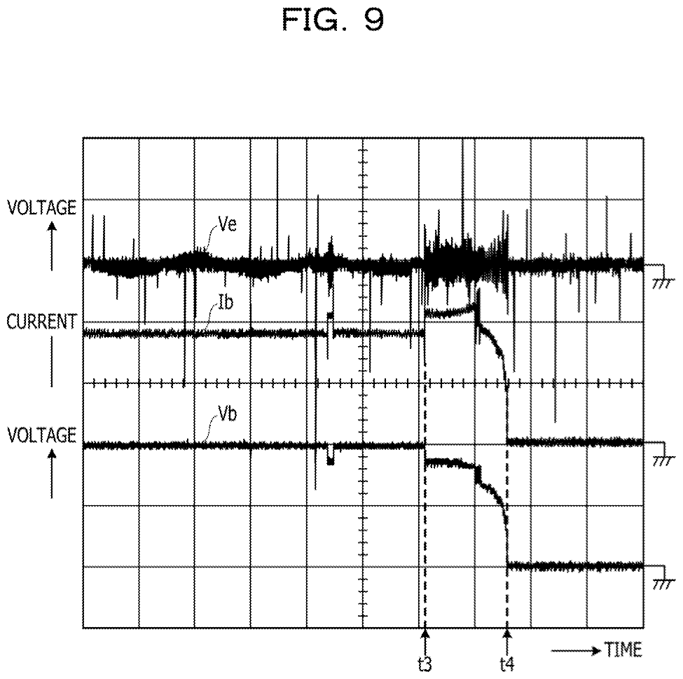

FIG. 9 is a diagram illustrating voltage waveforms and a current waveform in a case where an arc is occurring between the power transmission connector 20 and the power reception connector 10. A voltage waveform Ve represents an output voltage of an antenna that detects electromagnetic waves. When the arc continues to occur, the oscillation amplitude of the voltage waveform Ve continues to be large, and a period continues during which the voltage waveform Ve is sloped with the oscillation amplitude increased.

Interruption of the coupling between the power transmission connector 20 and the power reception connector 10 at the timing t3 results in the voltage waveform Ve having a large oscillation amplitude from the timing t3 to the timing t4. For example, when an arc is occurring between the power transmission connector 20 and the power reception connector 10, the period during which the oscillation amplitude is large is longer than that when no arc is occurring.

Using this feature, also in the third embodiment, the control circuit 30 outputs the instruction Sc for stopping the power supply generation operation of the power supply unit 310 based on the slope of the voltage waveform Sd. In a case where an arc occurs, the voltage waveform Ve has a slope accompanied by abnormal oscillation, which is a behavior different from that in a case where no arc is occurring. The control circuit 30 detects the slope accompanied by abnormal oscillation, which is a behavior different from that in a case where no arc is occurring, based on the slope of the voltage drop of the voltage waveform Sd. A continued arc results in a waveform with a continued slope accompanied by abnormal oscillation. The control circuit 30 determines that an arc is occurring by detecting a several-millisecond slope of the voltage waveform Sd.

Also in the third embodiment, the control circuit 30 outputs the instruction Sc for turning off the power supply to the load 320, to the power supply unit 310, when the slope A of the voltage waveform Sd exceeds the predetermined threshold B. Alternatively, the control circuit 30 may output the instruction Sc for turning off the power supply to the load 320, to the power supply unit 310, when the sloped time C of the voltage waveform Sd exceeds the predetermined threshold D. With the instruction Sc thus output, the continued occurrence of the arc may be suppressed.

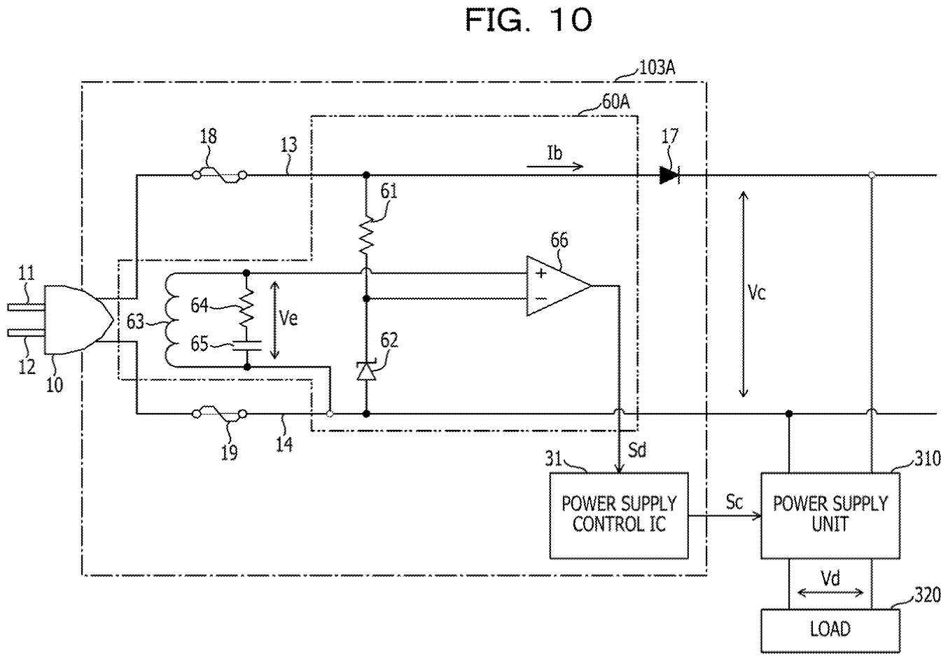

FIG. 10 is a diagram illustrating a configuration example of a power supply circuit according to the third embodiment. A power supply circuit 103A illustrated in FIG. 10 is an example of the power supply circuit 103 (FIG. 8). The power supply circuit 103A includes an electromagnetic wave detection circuit 60A instead of the voltage detection circuit 40A illustrated in FIG. 5. The electromagnetic wave detection circuit 60A is an example of the waveform output circuit 60 (FIG. 8).

The electromagnetic wave detection circuit 60A is a noise detection circuit that detects electromagnetic noise using an antenna 63. The electromagnetic wave detection circuit 60A outputs a voltage waveform Sd sloped when an arc is occurring between the power transmission connector 20 and the power reception connector 10, in accordance with a change in electromagnetic noise detected by the antenna 63.

The electromagnetic wave detection circuit 60A includes, for example, a resistor 61, a Zener diode 62, the antenna 63, a resistor 64, a capacitor 65, and an amplifier 66. An overvoltage protection circuit in which the resistor 61 and the Zener diode 62 are coupled in series is coupled between the pair of power supply lines 13 and 14. With this overvoltage protection circuit, no DC overvoltage Vb exceeding the Zener voltage of the Zener diode 62 is applied to an inverting input terminal of the amplifier 66. The antenna 63 is disposed inside or in the vicinity of the power reception connector 10, and is formed from, for example, a coil. The antenna 63 generates a detection voltage corresponding to the magnitude of electromagnetic noise input to the power reception connector 10, and the detection voltage is input to a non-inverting input terminal of the amplifier 66. A CR smoothing circuit in which the resistor 64 and the capacitor 65 are coupled in series smooths the detection voltage. The amplifier 66 amplifies an input voltage (a difference in potential between the non-inverting input terminal and the inverting input terminal) corresponding to the magnitude of the electromagnetic noise, and outputs the analog voltage waveform Sd equivalent to the magnitude of the electromagnetic noise.

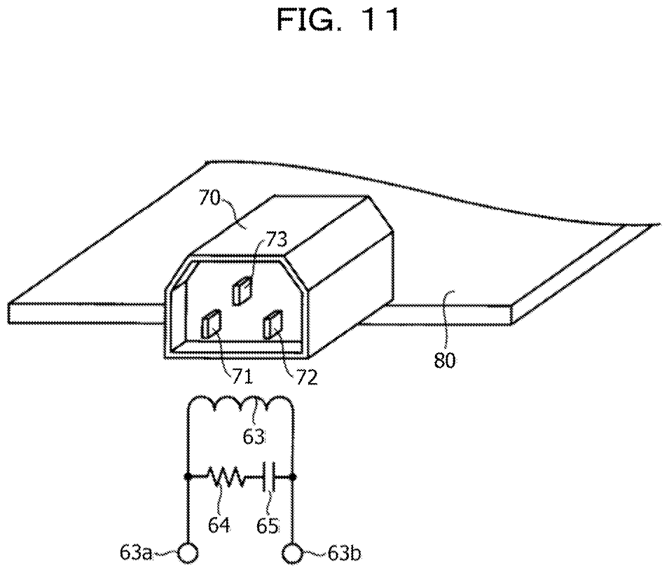

FIG. 11 is a diagram illustrating a first configuration example of the antenna. The antenna 63 is formed from, for example, an air-core coil. The antenna 63 and the CR components (the resistor 64 and the capacitor 65) are disposed in the vicinity of a connector 70. Both ends 63a and 63b of the antenna 63 are coupled to the input terminal of the amplifier 66 (FIG. 10). The connector 70 is an example of the power reception connector 10.

The connector 70 includes a positive-side power reception terminal 71, a negative-side power reception terminal 72, and a ground terminal 73 for grounding. The connector 70 may be mounted over a substrate 80. The electromagnetic wave detection circuit 60A may be mounted over the substrate 80 over which the connector 70 is mounted. With the power supply circuit 103A including the substrate 80 and the connector 70 mounted over the substrate 80 over which the electromagnetic wave detection circuit 60A is also mounted, the power supply circuit 103A may be downsized. With the connector 70 mounted over the substrate 80 over which the electromagnetic wave detection circuit 60A and the control circuit 30 are also mounted, the power supply circuit 103A may be further downsized.

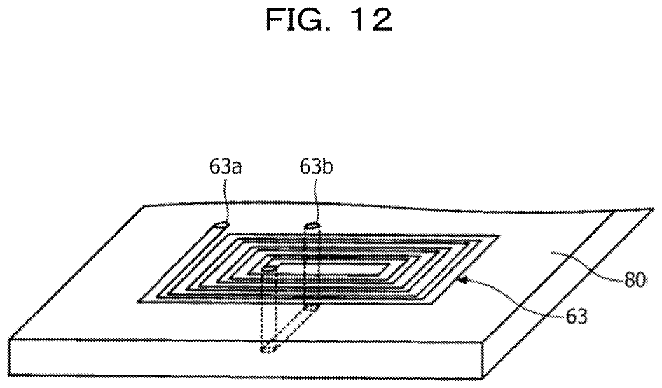

FIG. 12 is a diagram illustrating a second configuration example of the antenna. The antenna 63 may be formed from a conductor pattern provided to the substrate 80. FIG. 12 illustrates a configuration in which the antenna 63 is formed from a spiral conductor pattern. The connector 70 may be mounted to overlap the antenna 63 formed from the conductor pattern of the substrate 80. Thus, the power supply circuit may be downsized.

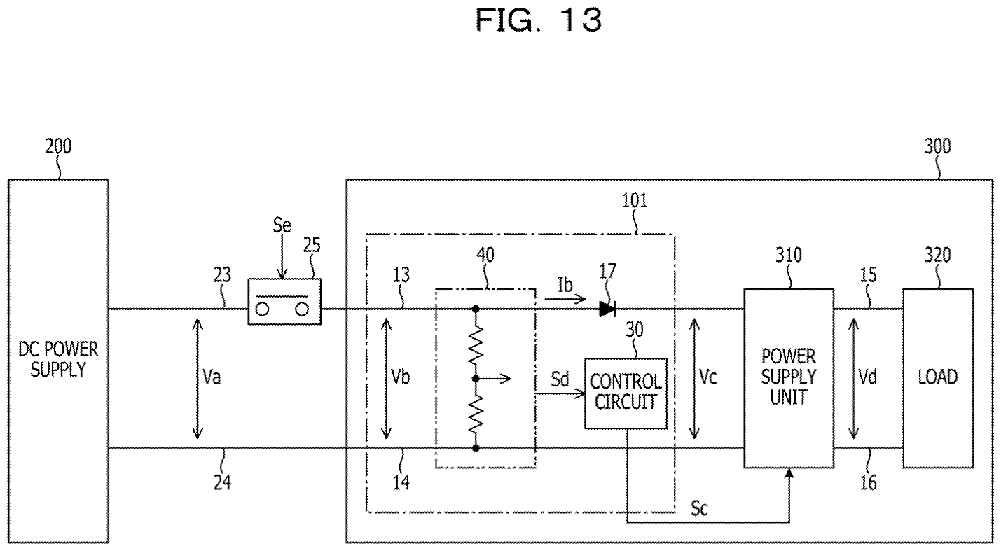

FIG. 13 is a diagram illustrating a configuration example of an electronic device according to a fourth embodiment. Description of the same configuration as that of the above-described embodiment will be omitted by incorporating the foregoing description. FIG. 13 illustrates a configuration in which an interruption mechanism 25 is inserted in series in a power supply cable between the DC power supply device 200 on the power transmission side and the power supply circuit 101 on the power reception side. The interruption mechanism 25 turns on and off the power supply line between the DC power supply device 200 and the power supply circuit 101, in response to a relay control signal Se supplied from a predetermined circuit. The interruption mechanism 25 is, for example, a relay. When the power supply cable is interrupted by the interruption mechanism 25, an arc may occur at the interrupted portion.

The waveform output circuit 40 outputs the voltage waveform Sd sloped when an arc is occurring, and the control circuit 30 outputs the instruction Sc for turning off the power supply to the load 320, to the power supply unit 310, when the slope of the voltage waveform Sd exceeds the threshold. In the fourth embodiment, the power transmission line 23 is an example of a power transmission unit, and the power supply line 13 is an example of a power reception unit. Thus, as in the above-described embodiments, the continued occurrence of an arc occurring during the turning off operation by the interruption mechanism 25 may be suppressed. While FIG. 13 illustrates a configuration in which the power supply circuit 101 according to the first embodiment is used, the power supply circuit 101 may be replaced with the power supply circuit of any of the other embodiments.

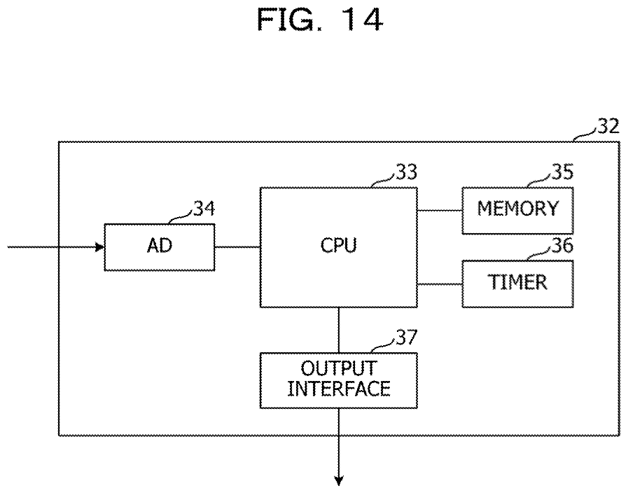

FIG. 14 is a diagram illustrating a hardware configuration example of a control circuit. The above-described control circuit 30 may be implemented using an analog circuit only or may be implemented using a control circuit 32 as illustrated in FIG. 14. The control circuit 32 includes a CPU 33, an analog-to-digital (AD) converter 34, a memory 35, a timer 36, and an output interface 37.

The functions of the control circuit 32 are implemented by, for example, the CPU 33 operating based on a program readably stored in the memory 35. The analog voltage waveform Sd is converted into digital values by the AD converter 34 to be supplied to the CPU 33. The instruction Sc is a signal output from the output interface 37.

Although the embodiments have been described, the technique of the present disclosure is not limited to the above-described embodiments. Various alterations and modifications such as combination and replacement with part or whole of other embodiments may be made.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power supply circuit comprising:
a power supply line through which DC power input from a first connector to a second connector is supplied to a power supply that generates power based on the DC power;
a waveform output circuit configured to output a voltage waveform sloped when an arc is occurring between the first connector and the second connector; and
a control circuit configured to output to the power supply an instruction for turning off the power supply when a slope of the voltage waveform exceeds a threshold.

2. The power supply circuit according to claim 1, wherein the power supply circuit comprising:
a power supply line through which DC power input from a first connector to a second connector is supplied to a power supply that generates the power based on the DC power;
a waveform output circuit configured to output a voltage waveform sloped when an arc is occurring between the first connector and the second connector; and
a control circuit configured to output to the power supply an instruction for turning off the power supply when a time during which the voltage waveform is sloped exceeds a threshold.

3. The power supply circuit according to claim 1, wherein
the waveform output circuit outputs the voltage waveform in accordance with a change in voltage input to the second connector.

4. The power supply circuit according to claim 1, wherein
the waveform output circuit outputs the voltage waveform in accordance with a change in current input to the second connector.

5. The power supply circuit according to claim 1, wherein
the waveform output circuit outputs the voltage waveform in accordance with a change in electromagnetic noise input to the second connector.

6. The power supply circuit according to claim 5, wherein
the second connector is mounted over a substrate over which the waveform output circuit is also mounted.

7. An electronic device comprising:
a load;
a power supply configured to generate power based on DC power input from a first connector to a second connector;
a power supply line through which the DC power is supplied to the power supply;
a waveform output circuit configured to output a voltage waveform sloped when an arc is occurring between the first connector and the second connector; and
a control circuit configured to output to the power supply an instruction for turning off the power supply when a slope of the voltage waveform exceeds a threshold.

8. An electronic device comprising:
a load;
a power supply configured to generate power based on DC power input from a first connector to a second connector;
a power supply line through which the DC power is supplied to the power supply;
a waveform output circuit configured to output a voltage waveform sloped when an arc is occurring between the first connector and the second connector; and
a control circuit configured to output to the power supply an instruction for turning off the power supply when a time during which the voltage waveform is sloped exceeds a threshold.
